(19) United States
(12) Patent Application Publication
(10) Pub. No.: US 2016/0269335 A1
(43) Pub. Date: Sep. 15, 2016

(54) METHOD AND APPARATUS FOR IDENTIFYING CHANGED MAILBOXES IN AN INTERNET MESSAGE ACCESS PROTOCOL (IMAP) LIST

(71) Applicant: TELEFONAKTIEBOLAGET L M ERICSSON (PUBL), Stockholm (SE)

(72) Inventor: Dave Kell, New Westminster (CA)

(21) Appl. No.: 14/657,017

(22) Filed: Mar. 13, 2015

(51) Int. Cl. H04L 12/58

(52) U.S. Cl. CPC H04L 51/22

(57) ABSTRACT

A method and Internet Message Access Protocol (IMAP) server for responding to a LIST request from an IMAP client device by returning a list containing only mailboxes having message content or metadata that has changed since the client device last synchronized with the mailboxes. The client device places in the LIST request, a BOXCHANGEDSINCE MODSEQ value, which is the highest modification sequence attribute (MODSEQ) value obtained by the client device when the client device last synchronized with the mailboxes. The server compares a current MODSEQ value for each mailbox with the BOXCHANGEDSINCE MODSEQ value received in the LIST request, and includes in the returned list, only mailboxes with current MODSEQ values higher than the BOXCHANGEDSINCE MODSEQ value received from the client device.

### TECHNICAL FIELD

The present disclosure relates generally to communication systems and more particularly to a method and apparatus for extending the Internet Message Access Protocol (IMAP) to identify changed mailboxes in an IMAP list.

### BACKGROUND

The IMAP Protocol (RFC3501) has many extensions published by the Internet Engineering Task Force (IETF) to improve the basic functionality of the protocol. Some of these extensions are specifically aimed at improving the efficiency of synchronization of an IMAP client device with the contents of an IMAP server. Three such extensions are RFC5258 (aka LIST-EXTENDED), RFC5819 (aka LIST-STATUS), and RFC7162 (aka CONDSTORE & QRESYNC).

RFC5258 (aka LIST-EXTENDED) introduced an extended syntax for the IMAP LIST operation, which returns in a LIST response, a list of mailboxes in the IMAP server. The LIST-EXTENDED extension also introduced the concept of constraining the resulting list based on “Selection options”. RFC5258 defines the Selection options SUBSCRIBED, REMOTE, and RECURSIVEMATCH, none of which is appropriate for finding mailboxes with changes.

RFC5819 (aka LIST-STATUS) published a specific extension of the LIST command, which returns STATUS information for each mailbox in the LIST response, without the client having to separately query the server for the STATUS of each mailbox. The returned status can indicate five things: MESSAGES, RECENT, UIDNEXT, UIDVALIDITY, and UNSEEN. Basically all of these status indicators give hints about new or changed mailbox content, although they do not specifically indicate what has changed, except that an increase in UIDNEXT means that new messages have arrived in the mailbox (though they might already be gone by this point). Once the status indicators for all of the mailboxes accessible by the user are received by the client device, the client device must analyze them and determine which mailboxes contain new or modified messages.

RFC7162 (aka CONDSTORE & QRESYNC) defines a modification sequence attribute (MODSEQ), which is associated with each message and each mailbox in the IMAP server. Currently CONDSTORE MODSEQ values can be accessed in the LIST-STATUS operation, and are displayed with the list of all mailboxes accessible by the user. This extension enables the IMAP client to query a downloaded mailbox for the messages that have changed or been added since the last time the client device synchronized with the server. Once again, since the entire list of mailboxes accessible by the user is returned, the client device must analyze the CONDSTORE MODSEQ values of all of the mailboxes to determine which mailboxes have message content or metadata that have changed.

Likewise, RFC7162 introduces in Section 3.1.7, a STATUS option named HIGHESTMODSEQ. This option enables the client device to send a LIST “” * RETURN (HIGHESTMODSEQ) request to the server. The server then returns a list of all mailboxes and the highest MODSEQ value for each mailbox. Once again, since the entire list of mailboxes accessible by the user is returned, the client device must analyze the highest MODSEQ values of all of the mailboxes, comparing them to the highest MODSEQ value previously obtained by the client device, to determine which mailboxes have message content or metadata that have changed since the client device last synchronized with the mailboxes.

### SUMMARY

Although the above-mentioned IMAP extensions allow more efficient synchronization of mailboxes by a client device, the LIST operation returns information for every mailbox accessible by the user and then requires the client device to do the analysis to determine which mailboxes have changed. If there are hundreds or even thousands of mailboxes, the LIST operation becomes very expensive from the point of view of resource utilization since information for every mailbox is returned. With a client device such as a mobile client, which connects and disconnects often, the implication is a very expensive operation to find which mailboxes may have changed. Typically, out of the large number of mailboxes available, only a few mailboxes (or none) will have changed; so much of the processing involved is unnecessary.

It is an object of the present disclosure to improve the basic functionality of the IMAP protocol by providing a more efficient method within the IMAP server for responding to LIST requests from IMAP clients. Essentially, the present disclosure introduces a new Selection option for the LIST command that accepts a MODSEQ value in order to shift the burden of analyzing the mailboxes to the server. The client device places a BOXCHANGEDSINCE MODSEQ value in the LIST request. The BOXCHANGEDSINCE MODSEQ value is a MODSEQ value previously obtained by the client device, and in an exemplary embodiment, is the highest MODSEQ value obtained by the client device when the client device last synchronized with the mailboxes. The server compares a current MODSEQ value for each mailbox with the BOXCHANGEDSINCE MODSEQ value received in the LIST request to identify mailboxes with current MODSEQ values higher than the BOXCHANGEDSINCE MODSEQ value received from the client device. Only these mailboxes are included in the returned list. Thus, the returned list of mailboxes only contains mailboxes modified later than the BOXCHANGEDSINCE MODSEQ value. When the BOXCHANGEDSINCE MODSEQ value received from the client device is the highest MODSEQ value obtained by the client device when the client device last synchronized with the mailboxes, the result is that the server includes in the returned list, only mailboxes having message content or metadata that has changed since the client device last synchronized with the mailboxes.

According to a first embodiment, the present disclosure provides a method in a server of providing to a client device, a list of mailboxes that store messages for a user. The server maintains a current mailbox reference number for each mailbox accessible by the user by detecting a change of message content in any of the mailboxes, and for each mailbox with a change of message content, updating an assigned current mailbox reference number to a value that is higher than any other current mailbox reference number for the mailboxes accessible by the user. The method further includes receiving from the client device, a request for the list of mailboxes, the request including a previous mailbox reference number obtained by the client device; generating the list of mailboxes by selecting for the list, only those mailboxes whose current mailbox reference number is greater than the received previous mailbox reference number; and sending the generated list of mailboxes to the client device, wherein the list includes only mailboxes having message content that has changed since the client device obtained the previous mailbox reference number.

According to another embodiment, the present disclosure provides a server for providing to a client device, a list of mailboxes that store messages for a user, wherein the server includes a processor that executes a server application program stored in a non-transitory memory. When the processor executes the server application program, the server is caused to maintain a current mailbox reference number for each mailbox accessible by the user, wherein the server is configured to detect a change of message content in any of the mailboxes, and for each mailbox with a change of message content, update an assigned current mailbox reference number to a value that is higher than any other current mailbox reference number for the mailboxes accessible by the user. The server is also caused to receive from the client device, a request for the list of mailboxes, the request including a previous mailbox reference number obtained by the client device; generate the list of mailboxes by selecting for the list, only those mailboxes whose current mailbox reference number is greater than the received previous mailbox reference number; and send the generated list of mailboxes to the client device, wherein the list includes only mailboxes having message content that has changed since the client device obtained the previous mailbox reference number.

The present disclosure also concerns a non-transitory computer-readable medium having stored thereon, computer programs comprising portions of software code in order to implement the method as described above when operated by a respective processor of a server. The computer-readable medium may be a permanent or rewritable memory within the server or located externally. The respective computer program may also be transferred to the server, for example, via a cable or a wireless link as a sequence of signals.

Thus, according to another embodiment, the present disclosure provides a non-transitory computer-readable medium having a computer-readable program stored thereon for operating on a server to provide to a client device, a list of mailboxes that store messages for a user. The program comprises instructions that cause the server to maintain a current mailbox reference number for each mailbox accessible by the user by detecting a change of message content in any of the mailboxes, and for each mailbox with a change of message content, updating an assigned current mailbox reference number to a value that is higher than any other current mailbox reference number for the mailboxes accessible by the user. The instructions also cause the server to perform the steps of receiving from the client device, a request for the list of mailboxes, the request including a previous mailbox reference number obtained by the client device; generating the list of mailboxes by selecting for the list, only those mailboxes whose current mailbox reference number is greater than the received previous mailbox reference number; and sending the generated list of mailboxes to the client device, wherein the list includes only mailboxes having message content that has changed since the client device obtained the previous mailbox reference number.

The present disclosure, therefore, provides for greatly abbreviated exchanges between the IMAP client and server to determine which mailboxes need to be synchronized. This reduces required transmission time, required bandwidth, required memory capacity, and required processing capacity.

Similarly, with faster processing of individual client synchronization cycles, more client devices can be synchronized in a fixed period of time, with potentially less server hardware required.

Since CONDSTORE is being recommended as mandatory within the Rich Communication Suite (RCS) for both servers and clients, implementation of the present disclosure on IMAP clients requires minimal incremental effort. Implementation on IMAP servers is also straightforward, and offers the opportunity to significantly improve the efficiency of mailbox synchronization within the implementation.

Further features and benefits of embodiments of the invention will become apparent from the detailed description below.

### BRIEF DESCRIPTION OF THE DRAWINGS

In the following section, the invention will be described with reference to exemplary embodiments illustrated in the figures, in which:

FIG. 1 (Prior Art) is a flow chart illustrating the steps of an existing method of mailbox synchronization using the IMAP protocol;

FIG. 2 is a flow chart illustrating the steps of an exemplary embodiment of the method of the present disclosure;

FIG. 3 is a signaling diagram illustrating the flow of messages during the method of the present disclosure; and

FIG. 4 is a simplified block diagram of an IMAP server and client device modified according to the present disclosure.

### DETAILED DESCRIPTION

The solution of the present disclosure will now be described more fully hereinafter with reference to the accompanying drawings, in which exemplary embodiments are shown. In the below, for purposes of explanation and not limitation, specific details are set forth in order to provide a thorough understanding of the disclosed solution. It will be apparent to one skilled in the art that the disclosed solution may be practiced in other embodiments that depart from these specific details.

Those skilled in the art will further appreciate that the functions explained herein below may be implemented using hardware circuitry or a combination of hardware and software. The software may be executed in conjunction with a programmed microprocessor or a general purpose computer, using an Application Specific Integrated Circuit (ASIC) and/or Digital Signal Processors (DSPs). It will also be apparent that when the present invention is described as a method, it may also be embodied in a computer processor and a non-transitory memory coupled to the processor, wherein the memory is encoded with one or more programs that perform the method when executed by the processor.

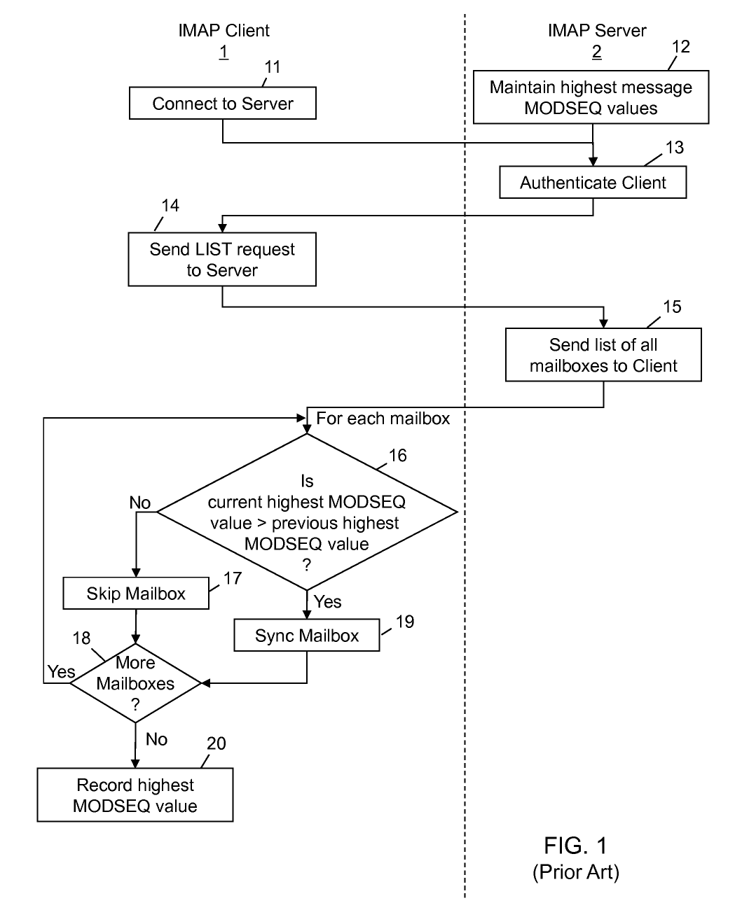

FIG. 1 is a flow chart illustrating the steps of an existing method of mailbox synchronization using the IMAP protocol. Steps performed by the IMAP client device 1 are shown on the left side of the drawing, and steps performed by the IMAP server 2 are shown on the right side of the drawing. At step 11, the IMAP client device connects to the IMAP server. Step 12 indicates that the IMAP server maintains, from the time the IMAP client device last synchronized with the mailboxes, a highest message MODSEQ value for each of the mailboxes accessible by the user. That is, a new, higher MODSEQ value is assigned to each new message received and/or to each message that is modified (for example, flags change). At step 13, the IMAP server authenticates the IMAP client device.

At step 14, the IMAP client device 1 sends a LIST request to the IMAP server 2. In this example, the LIST request is presumed to include a LIST command including the RETURN STATUS option including the HIGHESTMODSEQ attribute. The IMAP server responds at step 15 by sending the IMAP client device a list of all of the mailboxes accessible by the user, and includes a STATUS response for each mailbox, including the highest MODSEQ value for each mailbox and any other requested STATUS attributes. Since the entire list of mailboxes accessible by the user is returned, the IMAP client device must analyze the highest MODSEQ values of all of the mailboxes at step 16, comparing them to the highest MODSEQ value previously obtained by the IMAP client device, to determine which mailboxes have a current hightest MODSEQ value greater than the previous highest MODSEQ value obtained by the IMAP client device when the IMAP client device last synchronized with the mailboxes. If the current hightest MODSEQ value of a mailbox is not greater than the previous highest MODSEQ value obtained by the IMAP client device, the method moves to step 17 where the mailbox is skipped. At step 18 the client device determines whether there are more mailboxes to analyze. If so, the method returns to step 16 where the IMAP client device analyzes the next mailbox.

When the current hightest MODSEQ value of a mailbox is greater than the previous highest MODSEQ value obtained by the IMAP client device, the method moves to step 19 where the IMAP client device synchronizes with the mailbox. The IMAP client device then determines at step 18 whether there are more mailboxes to analyze. This methodology continues until there are no more mailboxes and the method moves to step 20 where the IMAP client device stores the highest MODSEQ value of all of the mailboxes.

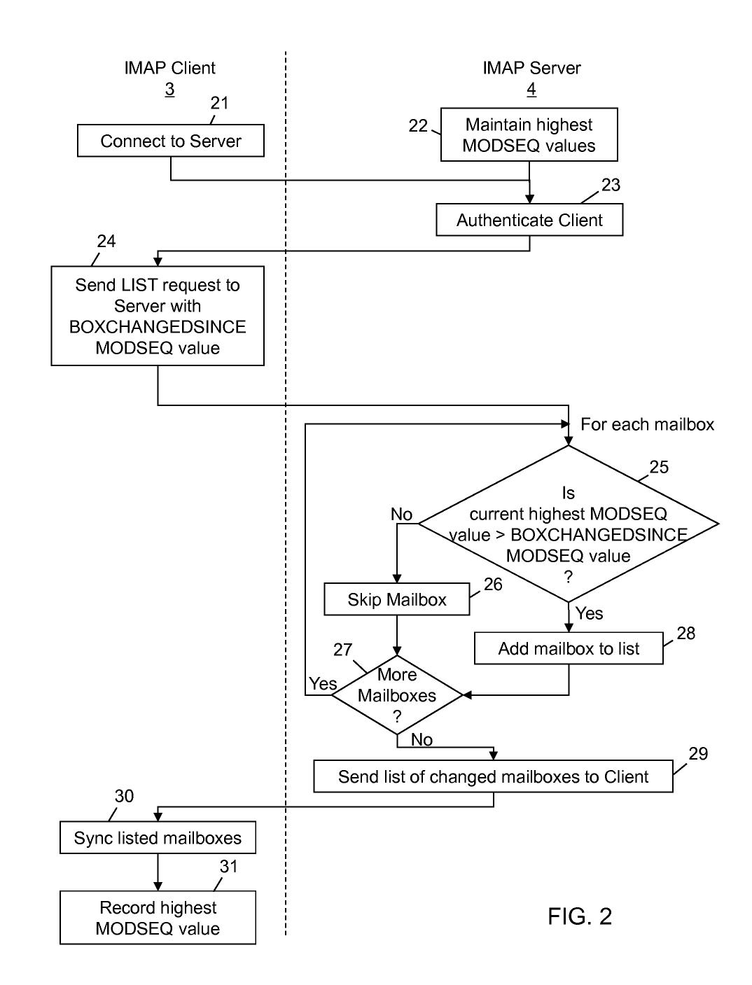

FIG. 2 is a flow chart illustrating the steps of an exemplary embodiment of the method of the present disclosure. The present disclosure provides an extension of the IMAP protocol for synchronizing messages stored on a server with a local copy of these messages on a client device. Specifically, the extension is an extension of IMAPv4.1, and affects both the client device and server apparatus involved in the exchange.

The synchronization of messages is of particular interest in scenarios where a user has multiple devices, such as is the case in RCS. However, after initial synchronization to get the devices roughly aligned with each other, further synchronizations typically involve few updates, and are normally focused on a very small number of mailboxes in which either mailbox metadata or message content within the mailboxes has been modified. Thus, it is beneficial to have a methodology in which the client device only has to analyze the mailboxes that have changed since the last time the client device synchronized with the mailboxes.

The solution described herein ensures that only changed mailboxes are returned in the LIST response. In addition, the LIST-STATUS (per RFC7162) of each mailbox in the LIST response is no longer required since the client device does not have to identify changed mailboxes and no longer needs this information to decide which mailboxes to synchronize. Thus the server returns only half as much information for each mailbox, and only for the mailboxes of interest. This significantly reduces the synchronization time (with associated computational and bandwidth benefits) for the average client synchronization operation.

Steps performed by the modified IMAP client device 3 (which may be referred to herein simply as “client”) are shown on the left side of the drawing, and steps performed by the modified IMAP server 4 (which may be referred to herein simply as “server”) are shown on the right side of the drawing. At step 21, the client connects to the server. Step 22 indicates that the server maintains, from the time the client last synchronized with the mailboxes, a highest MODSEQ value for each of the mailboxes accessible by the client. That is, a new, higher MODSEQ value is assigned to each new message received and/or to each message that is modified (for example, flags, annotations, or metadata change). The highest message MODSEQ value in a mailbox is then used as the MODSEQ value of the mailbox. A new, higher MODSEQ value may also be assigned to a mailbox when the metadata of the mailbox itself changes. It is noted that when a new, higher MODSEQ value is assigned to a message or a mailbox, the new, higher MODSEQ value is higher than any MODSEQ value previously assigned to any mailbox or any message in any of the mailboxes accessible by the client. The MODSEQ value is a positive 63-bit integer, which must always increase over time within any mailbox.

At step 23, the server authenticates the client. At step 24, the client 3 sends a LIST request to the server 4 and includes a new Selection option referred to herein as “BOXCHANGEDSINCE”. With this Selection option, the client requests that the LIST operation return only mailboxes that have MODSEQ values larger than the value provided with the BOXCHANGEDSINCE argument. For example,
A04 LIST (BOXCHANGEDSINCE 821102884)“” *
   returns a list of all mailboxes that have MODSEQ values larger than 821102884. This would represent all mailboxes that have changed since MODSEQ value 821102884 was generated. When the BOXCHANGEDSINCE MODSEQ value is the highest MODSEQ value the client previously obtained the last time the client synchronized with the mailboxes, then the list of all mailboxes that have MODSEQ values larger than the BOXCHANGEDSINCE MODSEQ value equates to a list of all mailboxes that have changed since the last time the client synchronized with the mailboxes.

It should be noted that in some circumstances, the BOXCHANGEDSINCE MODSEQ value received from the client device may not be the highest MODSEQ value the client previously obtained the last time the client synchronized with the mailboxes. For example, the client device may have crashed and did not save the MODSEQ value after the last synchronization. Or the client device may wish to resynchronize from an earlier known good state. In any event, the server returns a list of mailboxes that have MODSEQ values larger than the BOXCHANGEDSINCE MODSEQ value received from the client device.

The server 4 then analyzes the highest MODSEQ values of all of the mailboxes at step 25, comparing them to the BOXCHANGEDSINCE MODSEQ value received from the client 3, to determine which mailboxes have a current hightest MODSEQ value greater than the BOXCHANGEDSINCE MODSEQ value. If the current hightest MODSEQ value of a mailbox is not greater than the BOXCHANGEDSINCE MODSEQ value received from the client, the method moves to step 26 where the mailbox is skipped. At step 27 the server determines whether there are more mailboxes to analyze. If so, the method returns to step 25 where the server analyzes the next mailbox.

When the current hightest MODSEQ value of a mailbox is greater than the BOXCHANGEDSINCE MODSEQ value received from the client 3, the method moves to step 28 where the server 4 adds the mailbox to the list. The server then determines at step 27 whether there are more mailboxes to analyzes. This methodology continues until there are no more mailboxes and the method moves to step 29 where the server sends to the client, the list of mailboxes containing only changed mailboxes, i.e., mailboxes with changed message content (e.g., changed flags, annotations, or metadata) or changed mailbox metadata. At step 30, the client synchronizes with all of the mailboxes in the returned list. At step 31, the client records the highest MODSEQ value of all of the mailboxes. The client needs to keep track of the highest MODSEQ value seen in each synchronization, so that the same value can be passed to the server upon the next connection.

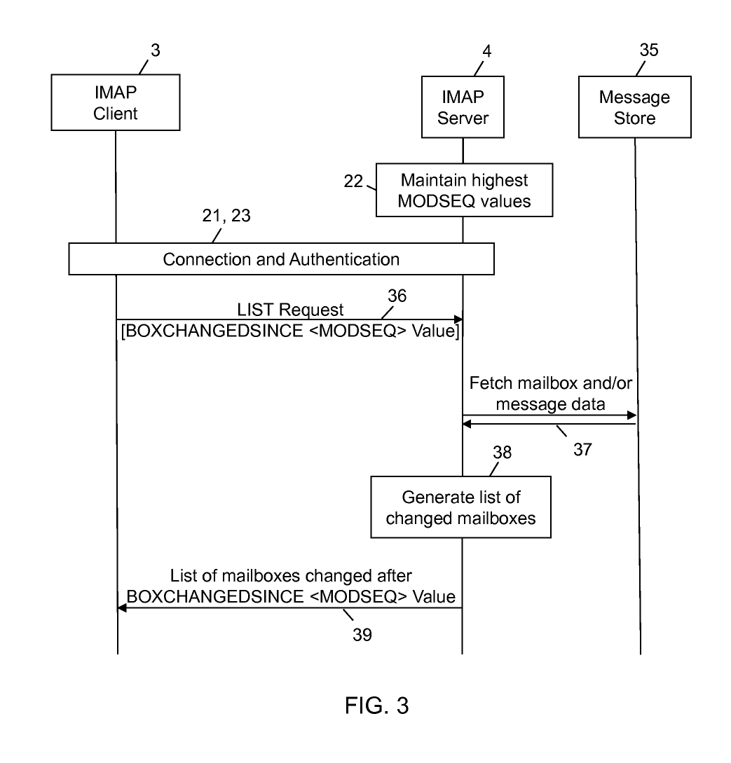

FIG. 3 is a signaling diagram illustrating the flow of messages between the modified IMAP client 3, the modified IMAP server 4, and a message store 35 when performing the method of the present disclosure. Initially at step 22, the server maintains, from the time the client last synchronized with the mailboxes, a highest MODSEQ value for each of the mailboxes accessible by the client. Following connection and authentication 21, 23, the client sends a LIST request 36 to the server 4 and includes the new BOXCHANGEDSINCE Selection option. The client provides a BOXCHANGEDSINCE MODSEQ value that is the highest MODSEQ value the client previously obtained the last time the client synchronized with the mailboxes. The server may maintain a list of mailboxes in an internal database, or the server may issue a database query 37 to the external message store 35 to fetch mailbox and/or message data. The server may fetch all mailbox and/or message data, or may fetch data only for mailboxes with current MODSEQ value>BOXCHANGEDSINCE MODSEQ value. The mailbox data may include mailbox metadata that has changed.

At step 38, the server 4 generates the list of changed mailboxes using either internally stored information or the information fetched from the message store 35. The server then returns to the client 3, a list 39 of mailboxes with current MODSEQ values greater than the BOXCHANGEDSINCE MODSEQ value (i.e., a list containing only mailboxes changed since the client last synchronized with the mailboxes.

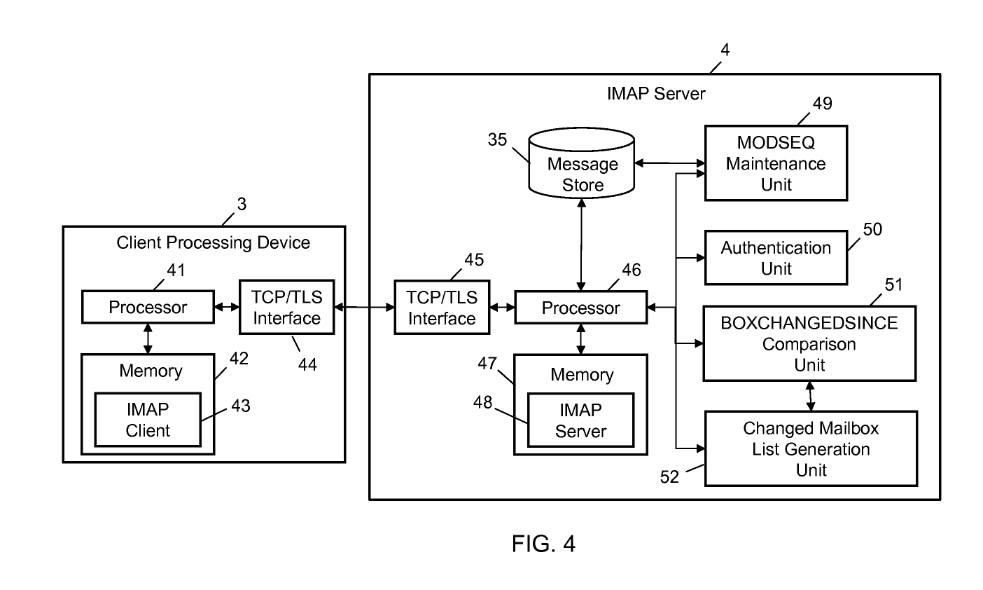

FIG. 4 is a simplified block diagram of an IMAP server and client modified according to the present disclosure. The server may be hosted, for example, on an enterprise-scale general computing platform such as a Unix server, a cluster of Unix servers, or a virtualized (cloud) server environment. The client may be hosted on a general purpose computer (for example, a PC) or a mobile device such as a smart-phone or tablet. The solution of the present disclosure does not modify the hardware associated with the client devices, but rather reduces the volume of exchanged information within the IMAP communication protocol.

On the server side, the disclosed solution offers significant opportunity to reduce memory use, reduce I/O traffic, and shorten synchronization times. Each of these aspects increases the number of client synchronization sessions that can be serviced within a given time interval.

Referring to FIG. 4, the modified client processing device 3 is shown to include a processor 41 and a non-transitory memory device 42 that stores the program instructions for the IMAP client functionality 43. The client program, for example, may be embedded in the manufacturer's Operating System (OS), or as an add-on application. A Transmission Control Protocol/Transport Layer Security (TCP/TLS) interface 44 provides a connection to the IMAP server 4.

The modified IMAP server 4 is shown to include a TCP/TLS interface 45 that provides a connection to the client 3. A processor 46 is coupled to a non-transitory memory device 47 that stores the program instructions for the IMAP client functionality 48. In this exemplary embodiment, the server is shown to include the message store 35 as an internal database, although it may alternatively be implemented external to the server. The processor controls four functional units including a MODSEQ Maintenance Unit 49, an Authentication Unit 50, a BOXCHANGEDSINCE Comparison Unit 51, and a Changed Mailbox List Generation Unit 52. These units may be implemented in hardware or software. The MODSEQ Maintenance Unit 49 enables the server to maintain a highest MODSEQ value for each of the mailboxes accessible by the client. The Authentication Unit 50 enables the server to authenticate the client when the client requests to connect to the server. The BOXCHANGEDSINCE Comparison Unit 51 enables the server to analyze the highest MODSEQ values of all of the mailboxes, comparing them to the BOXCHANGEDSINCE MODSEQ value received from the client, to determine which mailboxes have a current highest MODSEQ value greater than the BOXCHANGEDSINCE MODSEQ value. The Changed Mailbox List Generation Unit 52 enables the server to generate the list of mailboxes containing only changed mailboxes, i.e., mailboxes with message content or mailbox metadata that has changed since the client last synchronized with the mailboxes. The server then returns the list through the TCP/TLS interface 45 to the client.

### IMAP LIST Command Impact

As noted above, RFC5258 (aka LIST-EXTENDED) introduced Selection options, which are syntactically placed (if used) after the command name and before the mailbox specification. Thus the following command would apply the specified <list-selection-options> before returning the mailboxes that match these criteria:
A04 LIST (<list-selection-options) “” *

There is no impact on the Augmented Backus-Naur Form (ABNF) defined in Section 6 of RFC5258, as the new extension makes use of the “option-extension” ABNF definition, which allows for an option tag followed by an option value.

The present disclosure has no impact on the “RETURN” argument of the LIST command as used with the LIST-STATUS capabilities. That is, the new BOXCHANGEDSINCE capability can be used in LIST commands with or without the RETURN clause.

### CONDSTORE Implications

The server must assign MODSEQ values that are unique across all mailboxes accessible within a user session. Additionally, the MODSEQ value must always increase for any change in any mailbox. Some IMAP servers may have implemented CONDSTORE without this approach, since RFC 7162 allows for the use of the MODSEQ attribute on a per-mailbox basis. However, given that the MODSEQ attribute is a 63-bit integer (as described in Section 3.1 of RFC7162, there should be no problem with numeric overflow in real-world servers.

### QRESYNC Implications

RFC7162 also defined the QRESYNC capability, which extends the CONDSTORE concept to better identify deleted (expunged) messages within an IMAP server, as well as to reduce the effort to synchronize changes within a mailbox. The solution of the present disclosure works best with servers that have implemented QRESYNC, because the MODSEQ value will change for any mailbox for which any messages were deleted. This helps assure that the LIST operation can be used without LIST-STATUS in order to identify all impacted mailboxes.

Because RFC7162 strongly encourages that any CONDSTORE implementation should also implement QRESYNC, it can be assumed that the vast majority of server and client implementations are able to support this functionality. For any implementations where this is not true, the benefits of the LIST-BOXCHANGEDSINCE capability are still dramatic, but two lines of text will be returned for each mailbox instead of one, as the clients will probably use LIST-STATUS to return other STATUS items like UIDNEXT and MESSAGES in order to determine whether messages have been expunged.

### Advertising the BOXCHANGEDSINCE List Capability

A server implementing the LIST-BOXCHANGEDSINCE capability should publish an identifiable string in the CAPABILITY response for the server. For the purpose of this document, this string is referred to as “LIST-BOXCHANGEDSINCE”.

A server that advertises the LIST-BOXCHANGEDSINCE capability must accept a LIST command with the BOXCHANGEDSINCE argument as described above. The server should not have to implement full support for LIST-EXTENDED to accomplish this.

LIST (BOXCHANGEDSINCE) Behavior for Mailboxes with NOMODSEQ

RFC7162 defines behavior for mailboxes that do not support the MODSEQ attribute, wherein those mailboxes are reported as “NOMODSEQ” rather than providing a MODSEQ value for the mailbox.

The proposed LIST-BOXCHANGEDSINCE behavior for mailboxes that do not support the MODSEQ attribute is that they will not be included in the list of mailboxes returned by the LIST command when using the BOXCHANGEDSINCE argument.

### An Example of Synchronization

As an example, the following scenario is assumed for a specific user having 100 mailboxes, with two of those mailboxes containing changes since the last synchronization. With a server supporting LIST-STATUS and CONDSTORE, synchronization using existing procedures would include the following steps:

1. Client: Connect and authenticate;

2. Client: Issue LIST-STATUS command with HIGHESTMODSEQ argument;

3. Server: Return list of all mailboxes. For each mailbox in the list, return a STATUS response, including the HIGHESTMODSEQ value for the mailbox. Total: 200 lines of text (2 lines per mailbox);

4. Client: For each mailbox for which HIGHESTMODSEQ has changed since the last sync, SELECT/EXAMINE the mailbox and synchronize any changes; and

5. Client: Store the HIGHESTMODSEQ value.

The solution of the present disclosure affects steps 2-4. With support implemented for LIST-BOXCHANGEDSINCE, these steps would instead appear as follows:

2. Client: Issue LIST command with BOXCHANGEDSINCE argument;

3. Server: Return list of those mailboxes that have changed since the MODSEQ value provided with the CHANGESINCE argument. Total: 2 lines of text (1 line per changed mailbox); and

4. Client: SELECT/EXAMINE the mailboxes on the list and synchronize any changes.

The client/server exchange may take the following form:

C: a3 LIST (BOXCHANGEDSINCE 21823994) “” * RETURN (STATUS (UIDNEXT HIGHESTMODSEQ MESSAGES))

S: * LIST () “/” “Default/+10018555915”

S: * STATUS “Default/+10018555915” (UIDNEXT 3 HIGHESTMODSEQ 22012222 MESSAGES 2)

S: a3 OK LIST Completed

The only syntactic change from current standards is the introduction of the BOXCHANGEDSINCE argument within the LIST command (and a new CAPABILITY response string saying this new ability is supported by the server).

Note that the solution outlined here is not impacted by the size of the mailboxes themselves, but provides maximum benefits in environments with a large number of mailboxes and small percentage change per synchronization. This is typical in a messaging application such as RCS, and likely in most e-mail scenarios.

For many client interactions, the disclosed solution allows the client to issue a LIST command without requiring the LIST-STATUS capability, since the primary goal of LIST-STATUS was to identify which mailboxes need synchronization. When this is the case, the amount of data returned to the client may be reduced by 50 percent. This has a significant beneficial impact on client efficiency during synchronization, and reduces the load on the server.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method in a server of providing to a client device, a list of mailboxes that store messages for a user, the method comprising the steps of:
maintaining a current mailbox reference number for each mailbox accessible by the user, wherein maintaining includes:
detecting a change of message content in any of the mailboxes; and
for each mailbox with a change of message content, updating an assigned current mailbox reference number to a value that is higher than any other current mailbox reference number for the mailboxes accessible by the user;
receiving from the client device, a request for the list of mailboxes, the request including a previous mailbox reference number obtained by the client device;
generating the list of mailboxes by selecting for the list, only those mailboxes whose current mailbox reference number is greater than the received previous mailbox reference number; and
sending the generated list of mailboxes to the client device, wherein the list includes only mailboxes having message content that has changed since the client device obtained the previous mailbox reference number.

2. The method according to claim 1, wherein the previous mailbox reference number obtained by the client device is the highest previous mailbox reference number obtained by the client device when the client device last synchronized with the mailboxes, and the generated list of mailboxes includes only mailboxes having message content that has changed since the client device last synchronized with the mailboxes.

3. The method according to claim 1, wherein the step of generating the list of mailboxes includes comparing the current mailbox reference number for each of the mailboxes with the received previous mailbox reference number to determine which mailboxes have current mailbox reference numbers that are greater than the received highest previous mailbox reference number.

4. The method according to claim 1, wherein the change of message content includes at least one of:
a new message; and
modification of a flag, an annotation, or metadata of an existing message.

5. The method according to claim 1, wherein the client device and server communicate using an Internet Message Access Protocol (IMAP) extension.

6. The method according to claim 1, wherein maintaining a current mailbox reference number for each mailbox includes:
assigning a new modification sequence attribute (MODSEQ) value to any new or modified message, wherein the new MODSEQ value is higher than any MODSEQ value previously assigned to any message in any mailbox accessible by the user; and
utilizing the highest MODSEQ value in each mailbox as the current mailbox reference number for each corresponding mailbox.

7. The method according to claim 1, wherein maintaining a current mailbox reference number for each mailbox includes:
detecting a change of mailbox metadata for any of the mailboxes accessible by the user; and
assigning a new modification sequence attribute (MODSEQ) value to the mailbox with the changed metadata, wherein the new MODSEQ value is higher than any MODSEQ value previously assigned to any mailbox or any message in any mailbox accessible by the user.

8. A server for providing to a client device, a list of mailboxes that store messages for a user, wherein the server includes a processor that executes a server application program stored in a non-transitory memory, wherein when the processor executes the server application program, the server is caused to:
maintain a current mailbox reference number for each mailbox accessible by the user, wherein the server is configured to:
detect a change of message content in any of the mailboxes; and
for each mailbox with a change of message content, update an assigned current mailbox reference number to a value that is higher than any other current mailbox reference number for the mailboxes accessible by the user;
receive from the client device, a request for the list of mailboxes, the request including a previous mailbox reference number obtained by the client device;
generate the list of mailboxes by selecting for the list, only those mailboxes whose current mailbox reference number is greater than the received previous mailbox reference number; and
send the generated list of mailboxes to the client device, wherein the list includes only mailboxes having message content that has changed since the client device obtained the previous mailbox reference number.

9. The server according to claim 8, wherein the previous mailbox reference number obtained by the client device is the highest previous mailbox reference number obtained by the client device when the client device last synchronized with the mailboxes, and the generated list of mailboxes includes only mailboxes having message content that has changed since the client device last synchronized with the mailboxes.

10. The server according to claim 8, wherein the server generates the list of mailboxes by comparing the current mailbox reference number for each of the mailboxes with the received previous mailbox reference number to determine which mailboxes have current mailbox reference numbers that are greater than the received highest previous mailbox reference number.

11. The server according to claim 8, wherein the change of message content includes at least one of:
a new message; and
modification of a flag, an annotation, or metadata of an existing message.

12. The server according to claim 8, wherein the client device and server communicate using an Internet Message Access Protocol (IMAP) extension.

13. The server according to claim 8, wherein the server maintains a current mailbox reference number for each mailbox by:
assigning a new modification sequence attribute (MODSEQ) value to any new or modified message, wherein the new MODSEQ value is higher than any MODSEQ value previously assigned to any message in any mailbox accessible by the user; and
utilizing the highest MODSEQ value in each mailbox as the current mailbox reference number for each corresponding mailbox.

14. The server according to claim 8 wherein the server maintains a current mailbox reference number for each mailbox by:
detecting a change of mailbox metadata for any of the mailboxes accessible by the user; and
assigning a new modification sequence attribute (MODSEQ) value to the mailbox with the changed metadata, wherein the new MODSEQ value is higher than any MODSEQ value previously assigned to any mailbox or any message in any mailbox accessible by the user.

15. A non-transitory computer-readable medium having a computer-readable program stored thereon for operating on a server to provide to a client device, a list of mailboxes that store messages for a user, wherein the program comprises instructions that cause the server to perform the steps of:
maintaining a current mailbox reference number for each mailbox accessible by the user, wherein maintaining includes:
detecting a change of message content in any of the mailboxes; and
for each mailbox with a change of message content, updating an assigned current mailbox reference number to a value that is higher than any other current mailbox reference number for the mailboxes accessible by the user;
receiving from the client device, a request for the list of mailboxes, the request including a previous mailbox reference number obtained by the client device;
generating the list of mailboxes by selecting for the list, only those mailboxes whose current mailbox reference number is greater than the received previous mailbox reference number; and
sending the generated list of mailboxes to the client device, wherein the list includes only mailboxes having message content that has changed since the client device obtained the previous mailbox reference number.

16. The non-transitory computer-readable medium according to claim 15, wherein the previous mailbox reference number obtained by the client device is the highest previous mailbox reference number obtained by the client device when the client device last synchronized with the mailboxes, and the generated list of mailboxes includes only mailboxes having message content that has changed since the client device last synchronized with the mailboxes.

17. The non-transitory computer-readable medium according to claim 15, wherein the step of generating the list of mailboxes includes comparing the current mailbox reference number for each of the mailboxes with the received previous mailbox reference number to determine which mailboxes have current mailbox reference numbers that are greater than the received highest previous mailbox reference number.

18. The non-transitory computer-readable medium according to claim 15, wherein the change of message content includes at least one of:
a new message; and
modification of a flag, an annotation, or metadata of an existing message.

19. The non-transitory computer-readable medium according to claim 15, wherein the client device and server communicate using an Internet Message Access Protocol (IMAP) extension.

20. The non-transitory computer-readable medium according to claim 15, wherein maintaining a current mailbox reference number for each mailbox includes:
assigning a new modification sequence attribute (MODSEQ) value to any new or modified message, wherein the new MODSEQ value is higher than any MODSEQ value previously assigned to any message in any mailbox accessible by the user; and
utilizing the highest MODSEQ value in each mailbox as the current mailbox reference number for each corresponding mailbox.

21. The non-transitory computer-readable medium according to claim 15, wherein maintaining a current mailbox reference number for each mailbox includes:
detecting a change of mailbox metadata for any of the mailboxes accessible by the user; and
assigning a new modification sequence attribute (MODSEQ) value to the mailbox with the changed metadata, wherein the new MODSEQ value is higher than any MODSEQ value previously assigned to any mailbox or any message in any mailbox accessible by the user.
